(19) United States
(12) Patent Application Publication
(10) Pub. No.: US 2008/0320284 A1
(43) Pub. Date: Dec. 25, 2008

(54) VIRTUAL SERIAL-STREAM PROCESSOR

(76) Inventors: Jason Grzywna, Gainesville, FL (US); Walter Lee Hunt, Jr., Gainesville, FL (US)

Correspondence Address: LOWRIE, LANDO & ANASTASI, LLP, ONE MAIN STREET, SUITE 1100, CAMBRIDGE, MA, 02142, US

(21) Appl. No.: 12/143,579

(22) Filed: Jun. 20, 2008

Related U.S. Application Data
(60) Provisional application No. 60/945,471, filed on Jun. 21, 2007.

(51) Int. Cl. G06F 9/30

(52) U.S. Cl. 712/220; 712/E09.016

(57) ABSTRACT

A virtual serial-stream processor or system consists of one or more data input ports, zero or more data output ports, zero or more virtual control ports, one or more virtual serial and stream processing cores, one or more virtual serial control processors, and memory. Virtual components are spread across multiple physical devices, multiple virtual processing cores implemented in one physical device, or some combination, as dictated by an application-specific design.

### RELATED APPLICATIONS

This application claims priority under 35 U.S.C. § 119(e) to U.S. Provisional Application Ser. No. 60/945,471, entitled “System and Method for Serial-Stream Real-Time Data Acquisition and Processing,” filed on Jun. 21, 2007, which is herein incorporated by reference in its entirety.

### FIELD OF INVENTION

The present invention relates to optimized processing of streaming data, either through post processing or through real-time processing. This invention provides the biggest benefit to real-time processing of streaming data, although post-processing applications are also supported.

### SUMMARY OF INVENTION

The inventive system is a virtual serial-stream processing (“ViSSP”) system that is a solution for real-time data processing which is faster, more efficient, and possessing of a shorter design cycle than comparable state-of-the-art technology. The term “virtual” implies that ViSSP hardware resources are not necessarily discrete physical devices, although they can be.

ViSSP allows a pipelined algorithm with serial and/or parallel processing stages to be implemented such that each stage is performed by hardware that is most suited for the task. It is a novel configuration of serial and stream computing hardware that 1) provides shared memory space between one or more virtualized serial and stream processing cores, 2) supports a direct write to serial, shared, and/or stream processor memory space by a streaming data input source(s), and 3) implements a virtual data processing pipeline composed of the aforementioned processing hardware.

In one embodiment, the present invention consists of a virtualized data processing pipeline containing virtual or physical serial and stream processors that provide an optimized hardware solution for algorithms that have been factored into serial and parallel processing steps, and then designed as a single data processing pipeline with serial and parallel processing stages. Additionally, this invention provides an optional aspect, called a “VDT”, for rapid implementation of the pipeline stages in ViSSP hardware. In this embodiment, the process for using this invention follows.

First, the algorithm(s) of interest must be designed as a data processing pipeline, with each pipeline stage encapsulating one or more serial or parallel operations. This is most effectively accomplished utilizing knowledge of the target ViSSP hardware.

Next, the ViSSP data processing pipeline hardware implementation is performed using either the optional VDT software or the appropriate collection of design tools for the ViSSP's hardware resources. Use of a VDT is encouraged, since it dramatically reduces the time required to implement the data processing pipeline. The output of this step is a “pipeline definition file” which summarizes the data inputs, data outputs, operations, and target hardware (i.e. serial or parallel processor) for each stage, as well as control signal dependencies and any other required information.

Once the “pipeline definition file” is generated by the VDT, it is uploaded to the ViSSP hardware. The “pipeline definition file” specifies all behavior required by the ViSSP control processor to implement the data processing pipeline using the available virtual hardware resources. If no VDT was used, then all virtual hardware resources and the control processor must be programmed independently using traditional design tools.

The data processing pipeline can be executed when the control processor and all virtual hardware resources have been programmed. Pipeline execution works as follows. First, data is read from the input port(s) and the control processor is notified. The control processor oversees execution of each data processing pipeline stage by the virtual hardware resources. After the data processing pipeline is completed, the outputs are made available to the output port(s).

Typically, a small unmanned embedded system requires real time processing of the data from each of its sensors. In this case, the data processing pipeline is repeated once for every complete set of input data. Hardware systems that implement data processing pipelines are used today, but because of the architecture, this inventive system should be capable of more data processing at equivalent power and size than current state of the art (assuming a well-designed algorithm). In addition, when a ViSSP and VDT are used in conjunction, the time required to implement an algorithm design with this invention is dramatically reduced compared to traditional reconfigurable computing hardware.

An optional accessory to the inventive system is a ViSSP design tool (VDT) for rapid implementation of a data processing pipeline from a pipelined algorithm design which contains both serial and parallel pipeline stages which are executable by the inventive system's hardware resources. A ViSSP can exist without a VDT (the reverse is not true), but use of a VDT greatly reduces the length of the design cycle for systems containing this inventive system. When supported by ViSSP hardware, a VDT provides a method (graphical or otherwise) for defining pipeline stages. This method specifies the pipeline stage's type (i.e. serial vs. parallel), its data and control interface, the operation(s) to execute, and any additional dependencies that may exist for data and/or control inputs.

The inventive system is primarily intended for real-time processing of streaming data. However, this is merely a prediction for the primary method of use and not an inherent physical limitation of the invention. It can be used for more efficient non-real time processing in addition to its primary application.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a system component diagram of a solution for real-time processing of streaming data, according to the invention;

FIG. 2 is an example data processing pipeline that starts with a data source, contains both serial and stream processing stages, and ends with a data sink;

FIG. 3 is a diagram of the scheduling and execution of the example algorithm's serial and stream processing stages by the inventive system;

FIG. 4 is a data flow diagram showing the path taken by streamed input data from the inventive system's input port(s) to its computing memory;

FIG. 5 is a data flow diagram showing the path taken by data during system operation at all points between the input and output modules;

FIG. 6 is a control flow diagram showing control paths from the serial control module to other system components;

FIG. 7 is a minimal functional diagram for the VDT;

FIG. 8 is a system component diagram for an example implementation of the inventive system; and

FIG. 9 is a data processing pipeline example compatible with example system in FIG. 8.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof, is meant to encompass the items listed thereafter and equivalents thereof, as well as additional items.

Data processing systems can be assigned one of three classifications: 1) real-time, 2) non real-time or 3) pseudo real-time. The quantitative definition of “real-time” is application specific and is driven by high-level system-specific requirements. In general, a real-time system must complete processing tasks and produce a result within a finite and repeatable time window. If, at any time, the hardware fails to meet this requirement, data will be lost. By contrast, a non-real time system collects data with little or no processing during the collection process. Instead, raw data from a non real-time system is post-processed in a batch once the entire data collection procedure is complete. Pseudo real-time systems share characteristics of both other classifications, and represent the “gray area” between purely real-time and non real-time systems.

There exist modern data processing systems that meet the definition of real-time, but the class of embedded sensing hardware for small autonomous vehicles is possibly the most demanding in terms of system-level requirements for power consumption, weight, and size. These requirements constrain the amount of real-time data processing that is possible, limiting the functionality of the hardware. Since cutting-edge applications will have little or no excess hardware capacity, the efficiency of algorithms in such a system is critical.

Generally, an algorithm can be classified as serial, parallel, or a combination of the two. Operations in a serial algorithm must be performed sequentially, since the inputs to later stages are dependant on the output of earlier stages. Operations in a parallel algorithm are independent, and can be performed simultaneously on multiple independent data values. Only the simplest algorithms can be classified as being purely serial or purely parallel. Many advanced algorithms are a combination of both serial and parallel processing steps. The theoretical peak processing efficiency of the algorithm is achieved when serial processing steps (or stages, when the algorithm is converted to a data processing pipeline) are implemented with serial processing hardware and parallel processing steps are implemented with parallel (or stream processing) hardware. It is sometimes possible to port a serial algorithm step to a parallel implementation and vice versa, but this is inefficient and tends to reduce or eliminate performance gains versus an all-serial implementation.

Unfortunately, real system issues such as limited memory bandwidth, bus bandwidth, and chip area can prevent an optimized algorithm from realizing substantial performance improvements. Additionally, development of a pipelined algorithm consisting of both serial and parallel hardware is usually much more difficult than implementation of the same algorithm on a traditional serial processor.

The leading hardware device classes capable of implementing algorithms with a high degree of parallelism are the graphics processing unit (GPU) on modern graphics hardware (a stream processor) and the reconfigurable circuitry of a field-programmable gate array (FPGA) or similar device. Of these two, the FPGA can most easily implement both serial and parallel processing stages, while the GPU is the most efficient when dealing with floating-point precision data. Algorithm development for both devices is much more complex than traditional serial processors due to both the inherent complexity of the programming model and the lack of advanced design tools.

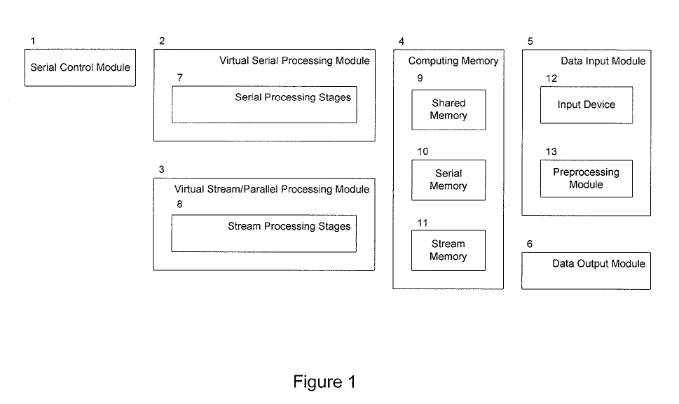

A data processing system for processing streaming data implemented in a ViSSP embodiment according to the invention is illustrated in FIG. 1. The system incorporates a serial control module 1, a serial processing module 2, a stream and/or parallel processing module 3, computing memory 4, a data input module 5, and a data output module 6.

The serial control module 1 is the brain of the inventive system. It generates control and timing signals for every other system-level component. The control and timing signals are derived from either a custom timing and control hardware module or the contents of a design file (description below). The serial control module 1 is a virtual serial processor core which can be implemented with one or more virtual cores in one or more reconfigurable hardware devices and/or with one or more physical interconnected processor cores.

The virtual serial processing 2 and stream/parallel processing 3 modules encapsulate the data processing capability of the inventive system. The serial processing module 2 consists of one or more virtual serial processing cores capable of executing instructions contained in the serial processing stages 7 of the pipelined algorithm. The stream/parallel processing module 3 consists of one or more virtual stream and/or parallel processing cores capable of executing instructions contained in the stream processing stages 8 of the pipelined algorithm. The processing modules 2, 3 can be implemented with one or more virtual cores in one or more reconfigurable hardware devices, or with one or more physical interconnected processor cores. It is also possible for the serial control module 1 and both processing modules 2, 3 to be virtual cores inside a single reconfigurable device. Also, if necessary, the serial control module and the serial processing module could be implemented using multiple execution threads on one core to conserve hardware resources.

The serial and stream processing stages 7, 8 executed by the serial and stream/parallel processing modules 2, 3 are processing stages of the pipelined algorithm implemented in the hardware of the inventive system. More information about the two types of processing stages and the associated pipelined algorithm design required by ViSSP will be provided later in this section.

The next key component of the inventive system is computing memory 4. Computing memory consists of shared memory 9 accessible by the serial control module 1 and both processing modules 2, 3, optional serial memory 10 accessible by the serial control module 1 and/or one or more cores in the serial processing module 2, and optional stream memory 11 accessible by one or more cores in the stream/parallel processing module 3.

The inventive system possesses a mechanism to transfer data to and from the shared memory. These functions are accomplished by the data input module 5 and data output modules 6. The data input module 5 consists of an input device 12 and an optional preprocessing module 13. The data output module 6 is highly application specific. It could be similar in structure to the data input module 5, or it could be nothing more than an interface to memory or other permanent storage. Alternately, the data output module 6 could be connected to or combined in the design with a data input module 5 for a subsequent ViSSP module.

To utilize this invention, an algorithm (or algorithms) must be designed as a data processing pipeline. This is accomplished during the algorithm design process by subdividing the algorithm into logical modules called stages, and then classifying the processing required by each stage as serial or stream/parallel processing. Definition of the processing operations and identification of data dependencies between stages, the inputs, and the outputs complete the design for the pipelined algorithm.

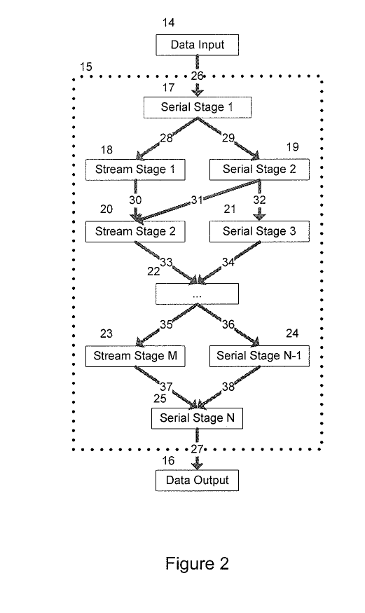

One possible example of a data pipeline, resulting from the design of a pipelined algorithm, which could be implemented with this inventive system, is shown in FIG. 2. Additionally, FIG. 2 is an illustrative embodiment of a possible graphical view for the VDT. This example is only intended for the purpose of illustration, and therefore should not be construed as being a complete representation of the pipeline control flow capabilities or a binding graphical design for the VDT.

FIG. 2 is an illustrative embodiment for the relationship between the data input stage 14, the data pipeline 15, and the data output stage 16. The illustrative embodiment in FIG. 2 shows one way that streaming data can flow through the system. Since design of the data pipeline 15 is application specific, the data pipeline stages 17-25 and the algorithm data dependencies 28-38 should only be construed as representing one of many possible data pipeline configurations 15 composing the inventive system. However, a dependence 26 of the data pipeline 15 on the data input stage 14 and a dependence 27 of the output stage 16 on the data pipeline 15 are general characteristics of the inventive system.

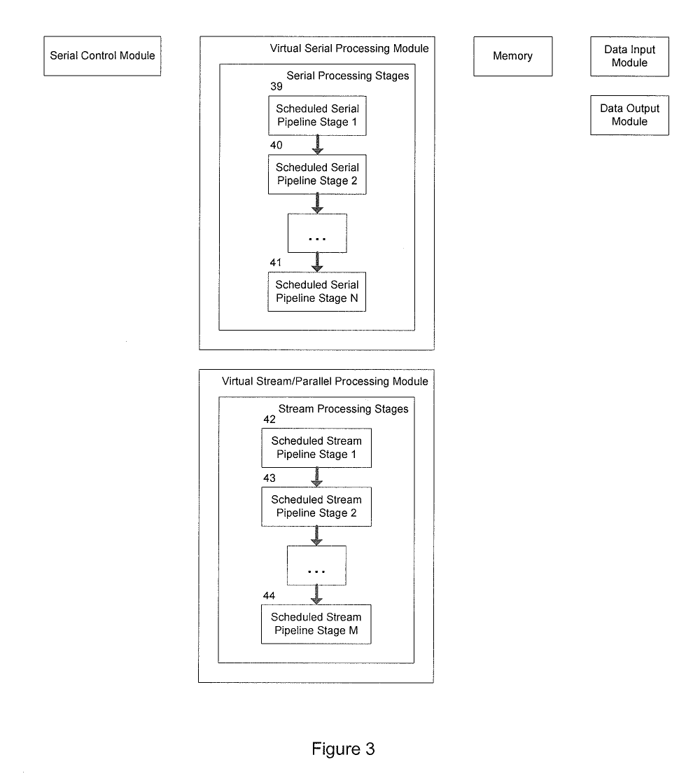

FIG. 3 is an illustrative embodiment of the execution of a data pipeline, such as the example data pipeline 15, by the virtual serial 9 and stream/parallel 10 processing modules. Because of finite hardware resources and data dependencies in the data pipeline, the serial control module 1 must schedule access to the virtual hardware resources by each stage. Each of the scheduled pipeline stages 39-44 are triggered by control signals from the serial control module 1 when all data dependencies are met and virtual hardware resources are available.

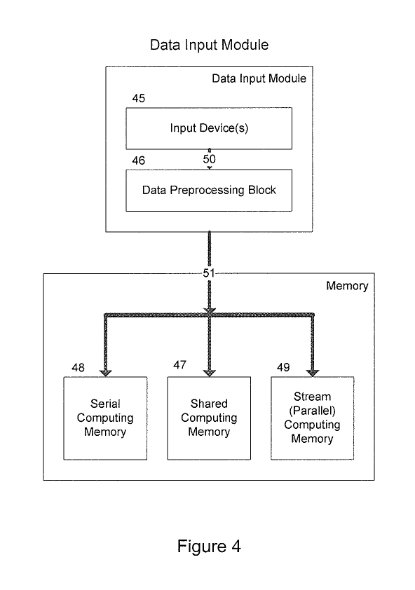

FIG. 4 is a data flow diagram showing data as it is streamed into the inventive system during typical operation. First, the data is read directly from the input device(s) 45. The data passes through an optional data preprocessing block 46 that, if present, applies a transformation to the streamed data prior to the initial write of this data to memory 51. The initial data write to memory 51 is most commonly made to shared computing memory 47; however, it may also go to serial 48 or stream 49 computing memory if they are present.

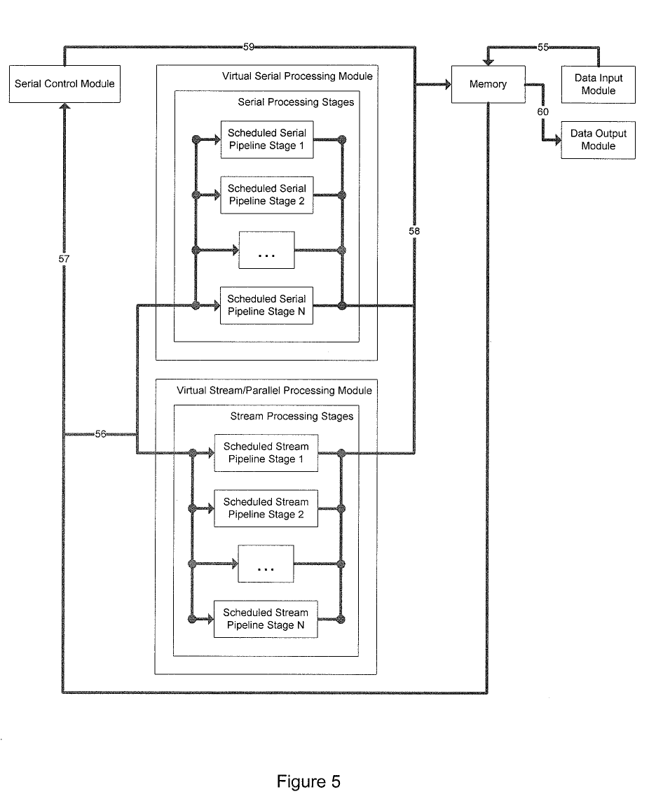

Now that the components of the inventive system are understood, it is possible to describe the method of operation. The system components implement a data processing pipeline for streamed data. The system data flow of the pipeline during normal operation is shown is shown in FIG. 5. The first step during system operation is the transfer 55 of the new data frame from the data input module 5 to computing memory 4. When this step is completed, the scheduled pipeline stages 39-44 execute according to timing determined by the serial control processor 1. Data flows 56 from computing memory 4 to the virtual processing modules 2, 3 as each stage commences. At the completion of each stage, the data flows 58 from the virtual processing modules 2, 3 back to computing memory 4. Any stage output that is subsequently used as a control signal flows 57 from computing memory to the serial control module 1. If the state of the control signal is modified by the serial control module 1, then it is returned 59 to computing memory. When all scheduled pipelines have completed, the output frame buffer is transferred 60 from computing memory to the data output module 6, where data output occurs. If sufficient memory is present, then the input data can be buffered before output has completed, resulting in increased data throughput.

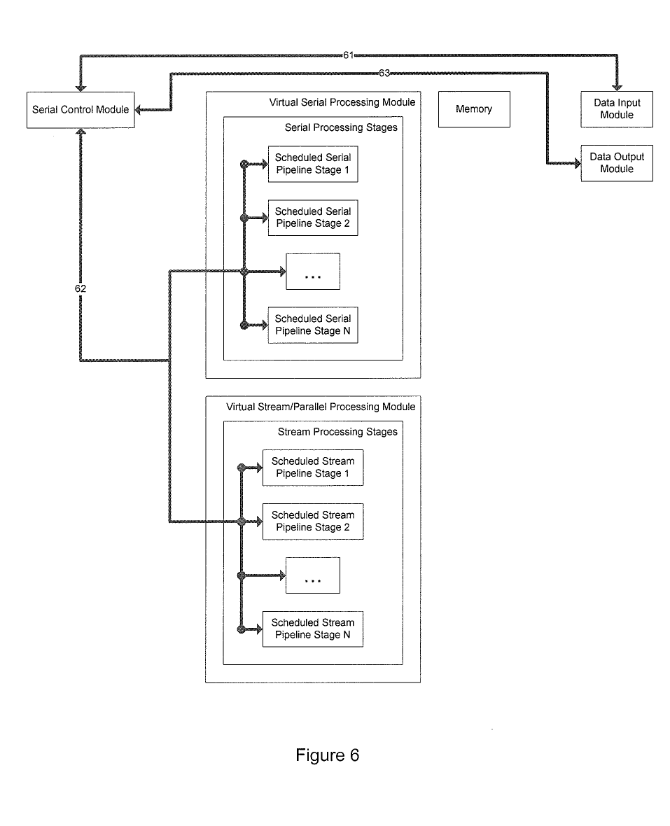

FIG. 6 illustrates how control signals are distributed within the system. As previously explained, the serial control module 1 is the master controller for the inventive system. Bidirectional control signals are initiated from serial control module 1 to the data input module 5 over data path 61. Data path 62 links the serial control module 1 and the virtual processing modules 2, 3, and data path 63 links the serial control module 1 to the data output module 6. External control signals for the inventive system are allowed, but are not shown in FIG. 6. If present, they would interface directly to the serial control module via an optional control input port, which is also not shown in any diagram.

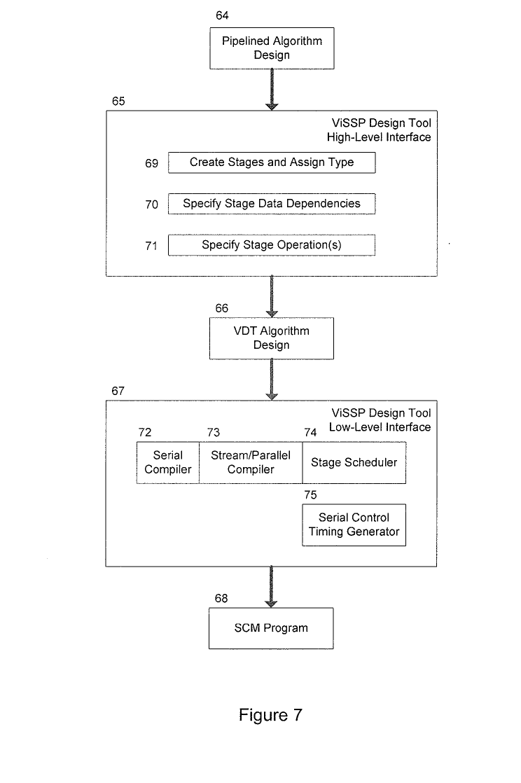

The ViSSP design tool, or VDT, is an optional accessory to the inventive system. It is capable of dramatically reducing the time required to port a pipelined algorithm to ViSSP. An illustrative embodiment of the VDT is provided in FIG. 7. The general purpose of the VDT is to convert a pipelined algorithm design 64 (such as the example in FIG. 2) to a serial control module program 68. First, a pipelined algorithm design 64 is converted to a VDT algorithm design 66 by the VDT high-level interface 65, which can be either text or GUI-based. The VDT high-level interface must create the pipeline stages and assign a type 69 (serial vs stream), specify any stage data dependencies 70, and specify the operation(s) 71 for each stage. Once completed, the result comprises what is called a completed VDT algorithm design 66. Next, the VDT must convert the VDT algorithm design 66 into an executable serial control module program 68. This is accomplished with the VDT low-level interface 67. The VDT low-level interface 67 contains, at a minimum, a compiler 72, 73 for both serial and stream/parallel processing modules, a stage scheduler 74, and a serial control module timing generator 75. The output of these components is a serial control module program 68 which contains all the steps necessary to control the virtual serial and stream/parallel processing modules 2, 3.

The following sections describe a sample implementation of the inventive system. It represents a high-level description of one possible configuration of the invention that may be commercially useful at the time of this writing. The capabilities of the system in this example are not intended to imply bounds for functionality of the inventive system as a whole, nor is this example intended to represent a “good” or a “complete” design of an inventive system.

### Example Application

The example ViSSP module is a machine vision processing board that computes the optical flow of a two-image sequence of raw Bayer data, and then passes an optical flow data vector and one full resolution RGB video frame to the output port. The optical flow data vector and RGB frame constitute the set of data that is refreshed every time a new output is available, which is collectively called the output data frame. The input data frame, which is defined as the complete set of inputs required to generate one output data frame, consists of two Bayer images from the camera streamed into the system at twice the desired output frame rate.

### Example Hardware

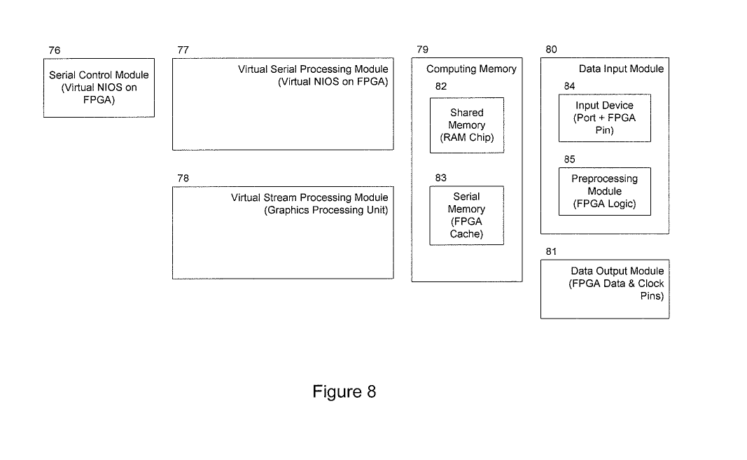

FIG. 8 shows a system diagram of the example inventive system. The inventive system's hardware consists of a serial control module 76 and serial processing module 77 implemented with two virtual processor cores inside an FPGA (for example, a virtual NIOS processor). The stream processing module 78 is implemented with a graphics processing unit (GPU) providing one or more programmable stream processors. (It could also have been implemented with a virtual FPGA core if one was available.)

Computing memory 79 of the embodiment is present in the form of a commercially available RAM module for shared computing memory 82 and the internal cache of the FPGA device as serial computing memory 83. The hypothetical GPU in this example system has no onboard cache, and since no memory mapped area addressable only by the GPU is provided, this example system has no stream computing memory. Instead, all memory accesses by the GPU must use the RAM module that is also accessible by the serial processing module.

Custom logic blocks implemented on the FPGA could be considered as additional serial processing module hardware (if sufficient serial architecture is present), additional stream/parallel processing module hardware (if sufficient stream/parallel architecture is present), or as a peripheral for one of the existing processing modules. Note that this example is simplified by assuming that no additional custom processing blocks accessible by the serial or stream processing modules are provided by the FPGA.

The data input module 80 for the exemplar system includes the input device 84, which is a port to physically connect the camera, which routes directly to pins on the FPGA. The preprocessing module 85 is a virtual component in the FPGA which implements a bi-linear interpolation de-Bayer filter on the input data as it is read from the camera, converting it from a Bayer image to an RGB image with the same resolution. The preprocessing module output is written directly to shared computing memory 82 and notification signal is provided to the serial control module 76.

### Example Pipelined Algorithm

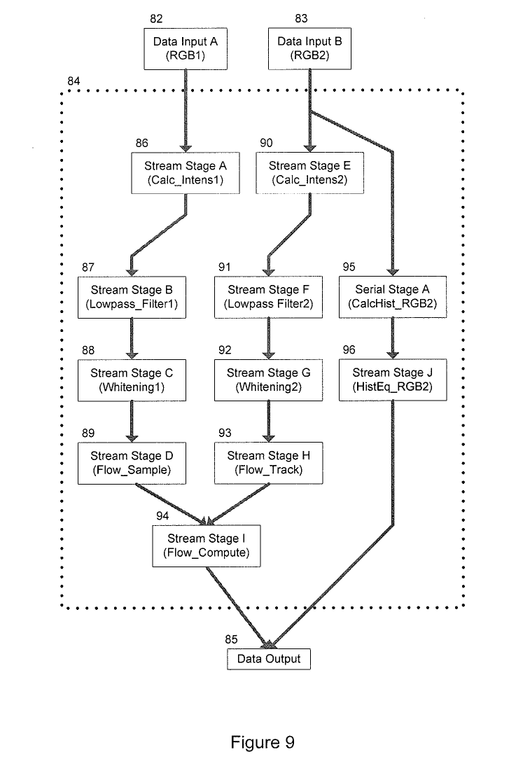

FIG. 9 shows what the pipelined algorithm design for the example might look like. This is merely an example, and shouldn't be construed to represent an optimal design. Like the generic conceptual diagram shown in FIG. 2, FIG. 9 represents processing stages implemented by the hardware. These stages could be specified at design time using a design compiled by the VDT or by direct programming of each hardware resource (but the latter represents a complex design path).

There are three main functions in this diagram. These are the data input 82-83, data processing 84, and data output 85 functions. The data processing stages compute each component of the output data frame. Stages 86-94 compute the optical-flow, and stages 95-96 generate the enhanced, full-resolution video frame.

The serial control module might select the following timing schedule for the pipeline stages: Calc_Intens1 86 (stream stage A), Lowpass_Filter1 87 (stream stage B), Whitening1 88 (stream stage C), Flow_Sample 89 (stream stage D), Calc_Intens2 90 and CalcHist_RGB2 95 (stream stage E and serial stage A), Lowpass_Filter2 91 (stream stage F), Whitening2 92 (stream stage G), Flow_Track 93 (stream stage H), Flow_Compute 94 (stream stage I), HistEq_RGB2 96 (stream stage J). Dependencies exist within this timing schedule; no stage can start until all of its inputs are available and its required hardware resource is free. For example, Calc_Intens1 86 cannot start until the data input module has finished writing RGB frame 1 to shared memory 82. Lowpass_Filter1 87 must wait until Calc_Intens1 86 is complete. Although Calc_Intens2 90 and CalcHist_RGB2 95 can occur simultaneously in separate hardware, neither stage can start until the data input module has finished writing RGB frame 2 to shared memory 83. Data output 85 occurs when every component of the output data frame is completed.

### Example System Operation

Once the pipelined algorithm is implemented in the hardware and deployed to the field, a typical mode of operation would be the generation of output data frames as fast as possible (i.e. measuring optical flow as fast as possible). The serial control module repeats the cycle described in this section until pipeline operation is halted by an external control signal, or until power is lost.

The data flow between components would be as follows. Data input occurs when a Bayer image passes from the camera, through the input device port, and to the preprocessing module. The preprocessing module applies a de-Bayer filter, converting the image to RGB format. Upon completion, the preprocessing module writes the data to a framebuffer in shared computing memory. The location of the framebuffer is provided to the data input module logic by the serial control module. Since this example requires buffering for two consecutive frames (called RGB1 and RGB2), the serial control module is responsible for toggling the input memory location between the RGB1 and RGB2 framebuffers.

The serial control module continually scans its list of stages during execution. If all data inputs for a stage are ready and the required hardware resource is idle, then the serial control module will load the stage program into the specified hardware and initiate program execution.

During execution, data is loaded from the shared memory to either the virtual NIOS core or to the GPU. After processing, it is returned to a temporary buffer in shared memory. Flow_Compute 94 and HistEq_RGB2 96 write to the output framebuffer, which is also located in shared memory for this example.

When both Flow_Compute 94 and HistEq_RGB2 96 complete, the serial control module signals the data output module to begin data output (which is unspecified in this example). Since the output and input framebuffers are different, the data input module could be triggered simultaneously with the data output module.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for processing data, the method comprising:
providing a serial control module that includes at least one serial processor core;
coupling a serial processing module, including at least one serial processor core, to the serial control module;
coupling a stream processing module, including at least one parallel or stream processor core, to the serial control module;
providing shared memory accessible by the serial control module, the serial processing module, and the stream processing module;
providing a data input module configured to transfer data into the shared memory and a data output module configured to transfer data out of the shared memory; and processing data by:
a. initializing the system by loading the serial control processor with either a pipeline data file or a native program corresponding to a desired algorithm and comprising serial and parallel stages;
b. transferring data from the data input module into the memory;
c. for serial stages of the pipeline data file, performing operations on the data within the serial processing module and, for parallel stages of the pipeline data file, performing operations on the data within the stream processing module; and
d. transferring the data from the memory to the data output module.

2. The method of claim 1, wherein the serial processor core of the serial control module is one of a virtual serial processor core and a physical serial processor core.

3. The method of claim 1, wherein the serial processor core of the serial processing module is one of a virtual serial processor core and a physical serial processor core.

4. The method of claim 1, wherein the parallel or stream processor core of the stream processing module is one of a virtual serial processor core and a physical serial processor core.

5. The method of claim 1, further comprising the step of coupling stream memory to one or more cores in the stream processing module.

6. The method of claim 1, further comprising the step of coupling the output module to a subsequent data processing system.

7. The method of claim 1, wherein the data input module further comprises a data preprocessing block.

8. The method of claim 1, wherein the data input module further comprises a data preprocessing block.

9. The method of claim 1, wherein the data comprises image data.

10. The method of claim 1, further comprising the step of using the data in the control system of an autonomous vehicle.

11. A data processing system, comprising:
a serial control module that includes at least one virtual or physical serial processor core;
a serial processing module, including at least one virtual or physical serial processor core, coupled to the serial control module;
a stream processing module, including at least one virtual or physical parallel or stream processor core, coupled to the serial control module;
instructions within the serial control module corresponding to a desired algorithm and comprising serial and parallel stages; and
wherein the system is configured such that instructions for serial stages cause the system to perform operations within the serial processing module, and instructions for parallel stages cause the system to perform operations within the stream processing module.

12. The system of claim 10, wherein the serial processor core of the serial control module is one of a virtual serial processor core and a physical serial processor core.

13. The system of claim 10, wherein the serial processor core of the serial processing module is one of a virtual serial processor core and a physical serial processor core.

14. The system of claim 10, wherein then serial processor core of the stream processing module is one of a virtual serial processor core and a physical serial processor core.

15. The system of claim 10, wherein the parallel processor core of the stream processing module is one of a virtual serial processor core and a physical serial processor core.

16. The system of claim 10, further comprising stream memory coupled to one or more cores in the stream processing module.

17. The system of claim 10, further comprising a subsequent data processing system coupled to the output module.

18. The system of claim 10, wherein the system is mounted on an autonomous vehicle.

19. A method for converting a pipelined algorithm into a serial control module program, the method comprising:
dividing a pipelined algorithm into stages, assigning each stage a serial or parallel type, and specifying data dependencies and operations for each stage to create a high level algorithm design; and
converting the high level algorithm design into a serial control module program by (a) compiling the serial stages for execution by a serial processing module, (b) compiling the parallel stages for execution by a parallel processing module, (c) adding stage scheduling information, and (d) adding timing signals.

20. The method of claim 19, wherein the pipelined algorithm comprises an algorithm for processing image data.
